(19) United States
(12) Patent Application Publication
(10) Pub. No.: US 2019/0238660 A1
(43) Pub. Date: Aug. 1, 2019

(54) SYSTEM AND METHOD FOR PLAYING BACK VIRTUAL REALITY 4D CONTENT

(71) Applicant: CJ 4DPLEX CO., LTD., Seoul (KR)

(72) Inventors: Hyun PARK, Seongnam-si (KR); Hyung Jin TAK, Seoul (KR)

(21) Appl. No.: 16/376,763

(22) Filed: Apr. 5, 2019

Related U.S. Application Data
(63) Continuation of application No. PCT/KR2017/010866, filed on Sep. 28, 2017.

(30) Foreign Application Priority Data
Oct. 5, 2016 (KR) 10-2016-0128223

(51) Int. Cl. H04L 29/06; G02B 27/01; G06F 3/01; G02B 27/00

(52) U.S. Cl. CPC H04L 67/38; G02B 27/0075; G06F 3/011; G02B 27/017

(57) ABSTRACT

Disclosed are a system and method for playing back virtual reality 4D content. The system for playing back virtual reality 4D content, includes an image server configured to provide content or an effect control signal, a head-mounted display (HMD) device configured to display the content, and a 4D apparatus configured to generate an effect synchronized with the content in response to the effect control signal.

### CROSS REFERENCE TO RELATED APPLICATION

This present application is a continuation of International Application Number PCT/KR2017/010866 filed on Sep. 28, 2017 which is based upon and claims the benefit of priority to Korean Patent Application No. 10-2016-0128223 filed on Oct. 5, 2016 in the Korean Intellectual Property Office. The disclosures of the above-listed applications are hereby incorporated by reference herein in their entirety.

### TECHNICAL FIELD

The present invention relates to a system and method for playing back virtual reality four-dimensional (4D) content and, more particularly, to a system and method for playing back virtual reality 4D content, which provide a 4D effect matched with content and a virtual reality effect when the content is played back in a theater.

### BACKGROUND ART

In a visual image screening facility, such as a theater or a movie theater, in a conventional technology, only a visual image has been screened. Recently, however, various effects are provided to audiences along with the screening of a visual image.

If a movie theater that plays back a common visual image is a two-dimensional (2D) movie theater and a movie theater that plays back a specially produced visual image so that audiences can feel a 3D effect when watching the visual image is a three-dimensional (3D) movie theater, a movie theater in which audiences can watch a visual image while feeling the five senses by stimulating a sense of touch, a sense of smell, etc. in addition to the senses of sight and hearing is a 4D movie theater.

In the 4D movie theater, a motion base that moves a chair in which an audience is seated is disposed under the chair, and a special effect device that provides various effects to the audience is disposed in the chair and the inside wall (or ceiling, etc.) of the movie theater.

When an audience watches a movie while being seated in a chair, he or she can not only watch the movie, but feel a motion and effects synchronized with the movie, such as water, wind, smoke, flash, heat and scent, thereby being capable of having a high interest in the movie and a high sense of immersion. In order to increase the interest of audiences as described above, a 4D movie theater provides the audiences with the feeling of the five senses using the motion chairs and special effect devices disposed in the 4D movie theater.

However, a visual image screened in the 4D movie theater is produced so that an audience can feel only the distance like the reality and can feel a 3D effect, but the visual image has a limit that makes an audience feel virtual reality that seems real.

### PRIOR ART DOCUMENT

### Patent Document

(Patent Document 1) Prior Art 1: Korean Patent Application Publication No. 2016-0082493 (laid open on Jul. 8, 2016)

### DISCLOSURE

### Technical Problem

An object of the present invention is to provide a system and method for playing back virtual reality 4D content, which provide a 4D effect matched with content and a virtual reality effect when the content is played back in a theater.

Another object of the present invention is to provide a system and method for playing back virtual reality 4D content, which enable content to be played back to be received using a mobile device and enable the content to be watched through an HMD device.

Yet another object of the present invention is to provide a system and method for playing back virtual reality 4D content, which can automatically set the focus of an HMD device worn by an audience.

Technical objects to be achieved by the present invention are not limited to the aforementioned objects, and those skilled in the art to which the present invention pertains may evidently understand other technological objects from the following description.

### Technical Solution

In accordance with an aspect of the present invention, there is provided a system for playing back virtual reality 4D content, including an image server configured to provide content or an effect control signal, a head-mounted display (HMD) device configured to display the content, and a 4D apparatus configured to generate an effect synchronized with the content in response to the effect control signal.

The image server may output an HMD device wearing message and provide a focus adjustment notification image after a predetermined specific time so that the focus of the HMD device is set.

The system may further include a mobile device connected to the HMD device through wired or wireless communication and configured to receive content from the image server. The HMD device may receive the content from the mobile device and display the received content.

The HMD device may transmit content playback time information to the image server in real time. The image server may perform synchronization with the 4D apparatus through communication using the time information.

The 4D apparatus may include a 4D chair configured to implement one or more effects of a ticker, vibration, an air shot, a water shot, a scent shot and a heater shot in response to the effect control signal.

Furthermore, the 4D apparatus may include a 4D effect device disposed within a theater and configured to implement at least one effect of snow, rain, wind, dewdrops, fog, heavy rain, lightning, a scent and light in response to the effect control signal.

The system may further include a central server configured to control the image server disposed in each theater. The image server may update existing content with new content if the new content is present in the central server.

The HMD device may provide a virtual reality effect when the content is displayed.

In accordance with another aspect of the present invention, there is provided an image server, including a content service unit configured to transmit content to be now played back to an HMD device or a mobile device connected to the HMD device and an effect control unit configured to receive content playback time information from the HMD device, perform synchronization with a corresponding 4D apparatus based on the time information, and transmit a control signal for an effect to be generated in a corresponding time to the corresponding 4D apparatus.

The content service unit may update existing content with new content if the new content is present in the central server.

The image server may further include an HMD device focus setting unit configured to output an HMD device wearing message and to provide a focus adjustment notification image after a predetermined specific time so that the focus of the HMD device is set.

In accordance with yet another aspect of the present invention, there is provided an HMD device, including a communication unit configured to receive content, a display unit configured to display the received content, and a control unit configured to control the content so that the content is displayed on the display unit.

The HMD device may further include a focus adjustment switch configured to adjust a focus so that the content is displayed on the display unit.

The control unit may transmit time information according to the playback of the content to an image server.

In accordance with yet another aspect of the present invention, there is provided a method of playing back virtual reality 4D content, including the steps of (a) transmitting, by an image server, content to be now played back to an HMD device, (b) displaying, by the HMD device, the content and transmitting time information according to the playback of the content to the image server, (c) performing, by the image server, synchronization with a corresponding 4D apparatus using the time information and transmitting an effect control signal to be generated in a corresponding time to the corresponding 4D apparatus, and (d) generating, by the 4D apparatus, an effect synchronized with the content in response to the effect control signal.

The method for playing back virtual reality 4D content may further include outputting, by the image server, an HMD device wearing message and providing a focus adjustment notification image after a predetermined specific time so that the focus of the HMD device is set prior to the step (a).

In accordance with yet another aspect of the present invention, there is provided a method of playing back virtual reality 4D content, including the steps of (a) transmitting, by an image server, content to be now played back to a mobile device connected to an HMD device, (b) storing, by the mobile device, the content and transmitting the stored content to the HMD device when a content playback start signal is received from the image server, (c) displaying, by the HMD device, the content and transmitting time information according to the playback of the content to the image server, (d) performing, by the image server, synchronization with a corresponding 4D apparatus using the time information and transmitting an effect control signal to be generated in a corresponding time to the corresponding 4D apparatus, and (e) generating, by the 4D apparatus, an effect synchronized with the content in response to the effect control signal.

The method for playing back virtual reality 4D content may further include outputting, by the image server, an HMD device wearing message and providing a focus adjustment notification image after a predetermined specific time so that the focus of the HMD device is set after the step (a).

The “method for playing back virtual reality 4D content” described above may be implemented in the form of a program, and may be recorded on a recording medium readable by an electronic device or distributed through a program download management device (e.g., a server).

### Advantageous Effects

In accordance with an embodiment of the present invention, the virtual reality technology is grafted onto the 4D system to provide virtual reality to audiences so that the audiences can feel a corresponding motion and environment effects. Accordingly, the audiences can have a greater interest and a higher sense of immersion by stimulating the five senses along with a visual effect according to virtual reality.

Furthermore, audiences can be provided with a virtual advertisement by grafting the virtual reality technology onto the 4D system.

Furthermore, the profits of a theater can be increased because a ticket price is raised or more customers are attracted through the present invention.

Furthermore, theater operating companies can increase their advertising revenues because they provide virtual reality content, and the quantitative and qualitative growth of a producer related to virtual reality content is expected because the public can easily learn about a virtual reality image in a theater. That is, advertisement sales and market can be activated due to the popularized virtual reality technology.

Furthermore, audiences who visit a theater can be provided with another pleasure because a 4D theater provides virtual reality content. In the case of a specific institute or school, field education can be performed in a theater with low cost. For example, schoolchildren can learn how to act when a fire occurs in a theater because they can experience a risk of fire through virtual reality.

Effects of the present invention are not limited to the aforementioned effects and may include various other effects within a range that is evident to a person having ordinary skill in the art from the following description.

### DESCRIPTION OF DRAWINGS

FIG. 1(a) FIG. 1(b) are diagram showing a system for playing back virtual reality 4D content according to an embodiment of the present invention.

FIG. 2 is an exemplary diagram of an HMD device according to an embodiment of the present invention.

FIG. 3 is a block diagram schematically showing the configuration of an image server according to an embodiment of the present invention.

FIG. 4 is a block diagram schematically showing the configuration of an HMD device according to an embodiment of the present invention.

FIG. 5 is a diagram showing a method for playing back virtual reality 4D content according to an embodiment of the present invention.

FIG. 6 is a diagram showing a method for playing back virtual reality 4D content according to another embodiment of the present invention.

<Description of Reference Numerals>

| | |
|---|---|
| 100: image server | 110: database |
| 120, 210: communication unit | 130: content service unit |
| 140: effect control unit | |
| 150: HMD device focus setting unit | |
| 160, 230: control unit | 200: HMD device |
| 220: display unit | 240: memory |
| 250: focus adjustment switch | 300: 4D apparatus |
| 310: 4D chair | 320: 4D effect device |
| 400: central server | 500: mobile device |

### MODE FOR INVENTION

The details of the objects and technological configurations of the present invention and corresponding acting effects will become more clearly understood from the following detailed description based on the drawings accompanied by the specification of the present invention.

Hereinafter, a “system and method for playing back virtual reality 4D content” according to embodiments of the present invention are described in detail with reference to the accompanying drawings. The embodiments are provided so that those skilled in the art may easily understand the technological spirit of the present invention and the present invention is not restricted by the embodiments. Furthermore, contents described in the accompanying drawings have been diagramed in order to easily describe the embodiments of the present invention, and may be different from forms that are actually implemented.

Elements to be described herein are only examples for implementing the embodiments of the present invention. Accordingly, in other implementations of the present invention, different elements may be used without departing from the spirit and scope of the present invention. Furthermore, each of the elements may be implemented by only a hardware or software element, but may be implemented by a combination of various hardware and software elements that perform the same function. Furthermore, two or more elements may be together implemented by one piece of hardware or software.

Furthermore, an expression that some elements are “included” is an expression of an “open type”, and the expression simply denotes that the corresponding elements are present, but should not be construed as excluding additional elements.

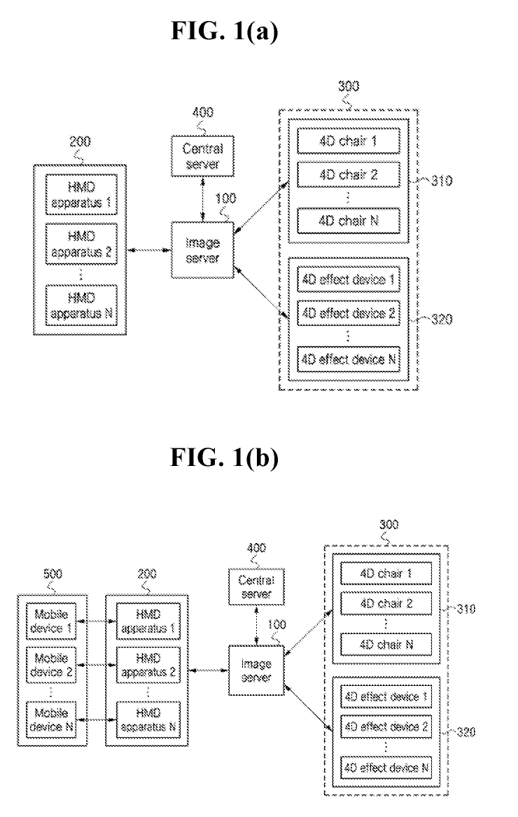

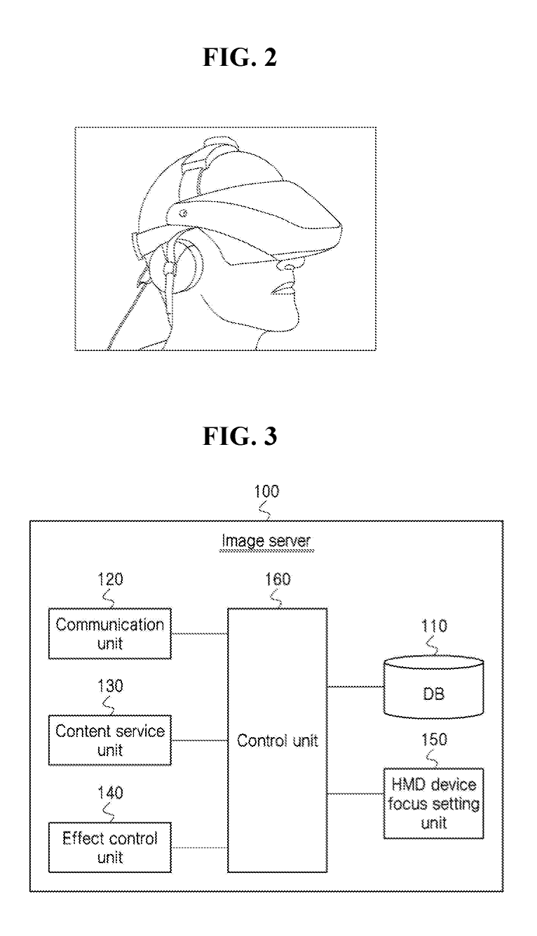

FIG. 1(a) FIG. 1(b) are diagram showing a system for playing back virtual reality 4D content according to an embodiment of the present invention, and FIG. 2 is an exemplary diagram of an HMD device according to an embodiment of the present invention.

Referring to FIG. 1(a) FIG. 1(b), the system for playing back virtual reality 4D content includes an image server 100, a head-mounted display (HMD) device 200 and a 4D apparatus 300, which are connected over a communication network. In this case, the communication network may include any communication form including wired communication and wireless communication, and may include various communication networks, such as a local area network (LAN), a metropolitan area network (MAN) and a wide area network (WAN).

The image server 100 is disposed in each theater and provides content to be now played back or an effect control signal according to the content. In this case, the content may be information including video (or image), such as a movie, an advertisement and field education. The effect control signal may be a signal for implementing one or more effects of a tickler, a vibration effect, snow, rain, wind, dewdrops, fog, a scent, and light.

The image server 100 outputs an HMD device wearing message and sets the focus of the HMD device 200 after a predetermined specific time. In this case, the HMD device wearing message is a message that provides notification of the wearing of the HMD device, and may be output in various forms, such as voice and/or video. An audience who hears or watches the HMD device wearing message may wear the HMD device 200.

The image server 100 adds a separately produced focus adjustment notification image to the front part of content and provides a spare time during which the HMD device 200 worn by an audience can be focused. That is, after a predetermined specific time (e.g., 3 seconds˜5 second) elapses since a focus adjustment notification image is provided, the image server 100 performs the task of setting the focus of the audience on the center. There is no problem when the audience normally wears the HMD device 200. However, when the audience wears the HMD device 200 in the state in which he or she has turned his or her head to the left or right, the direction of the HMD device 200 leans to the right or left. In this case, the audience who has worn the HMD device 200 cannot watch the center of normal video, and thus he or she can manually focus the HMD device 200 on the center using a separate switch included in the HMD device 200.

The image server 100 generates an effect control signal for controlling an effect of the 4D apparatus 300 in response to a situation and transmits the generated effect control signal to one or more 4D apparatuses 300. That is, the image server 100 receives content playback time information from the HMD device 200 in real time, performs synchronization with the 4D apparatus 300 through communication using the time information, and transmits an effect control signal to be generated to a corresponding 4D apparatus in a corresponding time.

As described above, the image server 100 provides notification of the wearing of the HMD device so that an audience can wear the HMD device 200. Thereafter, the image server 100 provides content to be now played back to the HMD device 200 worn by the audience to implement a virtual reality effect and also provides an effect control signal suitable for the corresponding content to the 4D apparatus 300 to implement various effects.

The HMD device 200 is connected to the image server 100, and receives content from the image server 100 and displays the received content. The HMD device 200 provides a virtual reality effect when the content is displayed. For example, assuming that the content is a roller coaster, the HMD device 200 provides a feeling that an audience rides an actual roller coaster to the audience who has worn the HMD device 200.

The HMD device 200 transmits content playback time information to the image server 100 in real time. In response thereto, the image server 100 performs synchronization with the 4D apparatus 300 using the time information.

The HMD device 200 is disposed in each chair or person within a theater. When an audience is notified of the wearing of the HMD device, the audience wears the HMD device 200 on his or her head.

The HMD device 200 may have a form that has a communication function and a data processing function, for example, and can be worn on a user's head as shown in FIG. 2. The HMD device 200 worn by the user displays content on a screen. In this case, the HMD device 200 may display the content of a predetermined size at a predetermined location. Furthermore, the HMD device 200 may have a form of glasses. The HMD device 200 may be temporarily fixed to the user's head by a frame.

The HMD device 200 may be divided into a first type in which a CPU and a display are included in the HMD device and a second type in which a mobile device 500 can be mounted on the HMD device 200. In the case of the second type, the mobile device 500 functions to control the HMD device 200 so that it displays content.

The first type has a structure, such as that shown in FIG. 1(a). The HMD device 200 receives content from the image server 100 and displays the received content.

The second type has a structure, such as that shown in FIG. 1(b). The HMD device 200 is connected to the mobile device 500 through wired and/or wireless communication. The mobile device 500 receives content from the image server 100. The HMD device 200 receives the content from the mobile device 500 and displays the received content.

In the case of the second type, the HMD device 200 may be connected to the mobile device 500 and the image server 100 through communication. The HMD device 200 is designed to output content received from the mobile device 500. In this case, the HMD device 200 receives the content from the mobile device 500 using the Miracast technology and displays the received content.

The mobile device 500 connected to the HMD device 200 may be a smartphone, a tablet PC, a PC, smartTV, a mobile phone, a personal digital assistant (PAD), a laptop, a media player, a micro server, a global positioning system (GPS), an e-book terminal, a terminal for digital broadcasting, a navigator, kiosk, an MP3 player, a digital camera or other mobile computing devices, but is not limited thereto. Furthermore, the mobile device 500 may be a watch or band having a communication function and a data processing function, but is not limited thereto.

As described above, the mobile device 500 and the HMD device 200 are interconnected through wired or wireless communication. For data pairing between the HMD device 200 and the mobile device 500, the Miracast technology or Wi-Fi Direct technology may be applied.

The 4D apparatus 300 is connected to the image server 100, and generates an effect synchronized with content in response to an effect control signal transmitted by the image server 100.

The 4D apparatus 300 may include a 4D chair 310 in which a user is seated when the user watches content or a 4D effect device 320 disposed on the inside wall or ceiling of a theater in order to provide various effects to audiences while operating in conjunction with content. When content is started, the 4D chair 300 provides a motion and vibration in accordance with the content, and the 4D effect device 320 generates 4D effects, such as snow, rain, wind, dewdrops, fog, heavy rain, lightning, a scent and light, in real time in accordance with the content.

The 4D apparatus 300 may include a function unit for driving devices that implement actual special effects, that is, a plurality of effects devices. A program, that is, firmware necessary to control the effects devices, has been installed in the function unit. In general, the firmware is recorded on a storage space within the function unit, more specifically, ROM and includes a control command for all the effects devices that form the 4D apparatus 300. The function unit in which the firmware has been installed receives an effect control signal from the image server 100 and controls the effects devices through the firmware.

The 4D apparatus 300 synchronizes time code in order to communicate with the image server 100 in real time while content is screened. That is, when the screening of the content is started, the image server 100 and the 4D apparatus 300 perform time code synchronization in order to make identical their time information referred by them. Accordingly, although a variable is generated, such as that the 4D apparatus 300 needs to be separately controlled while content is screened or that the 4D apparatus 300 needs to be reset due to a sudden error, the image server 100 can take proper measures at an appropriate time with reference to time code shared with the 4D apparatus 300.

The system for playing back virtual reality 4D content configured as described may further include a central server 400 for controlling the image server 100 disposed in each theater.

The central server 400 controls a plurality of the image servers 100 and provides content to the image server 100 disposed in each theater. If new content is present in the central server 400, the image server 100 updates existing content with the new content.

In this case, although only one image server 100 has been illustrated, it is evident that the central server 400 may control a plurality of the image servers 100.

FIG. 3 is a block diagram schematically showing the configuration of the image server according to an embodiment of the present invention.

Referring to FIG. 3, the image server 100 includes a database (DB) 110, a communication unit 120, a content service unit 130 and an effect control unit 140.

Content that is being screened or scheduled to be screened and information about the content are stored in the DB 110.

The communication unit 120 transmits and receives data to and from various electronic devices. Specifically, the communication unit 120 connects the image server 100 to the HMD device or the 4D apparatus over a wired communication network or wireless communication network.

The content service unit 130 extracts content to be played back from the DB 110 and transmits the extracted content to the HMD device or the mobile device connected to the HMD device.

The content service unit 130 updates existing content with new content if the new content is present in the central server.

The effect control unit 140 receives time information according to the playback of content from the HMD device, performs synchronization with a corresponding 4D apparatus through communication based on the time information, and transmits an effect control signal for an effect to be generated in a corresponding time to the corresponding 4D apparatus. In this case, the effect control signal may be a signal for implementing one or more effects of a tickler, a vibration effect, snow, rain, wind, dewdrops, fog, a scent and light.

The image server 100 configured as described above may further include an HMD device focus setting unit 150.

The HMD device focus setting unit 150 outputs an HMD device wearing message and provides a focus adjustment notification image after a predetermined specific time so that an HMD device is focused on the center. The HMD device wearing message may be output in various forms, such as voice and/or video. An audience watches the HMD device wearing message and wears the HMD device.

The HMD device focus setting unit 150 performs the task of setting the focus of an audience who has worn the HMD device on the center by providing a focus adjustment notification image. The focus adjustment notification image may be added to the front part of content provided by the content service unit 130 and provided or may be separated produced and provided.

Each of the content service unit 130, the effect control unit 140 and the HMD device focus setting unit 150 may be implemented by a processor necessary to execute a program on a computing device. As described above, the content service unit 130, the effect control unit 140 and the HMD device focus setting unit 150 may be implemented by physically separated elements, respectively, or may be implemented in a form in which they are functionally divided within a single processor.

A control unit 160 controls the operations of various elements of the image server 300, including the DB 110, the communication unit 120, the content service unit 130, the effect control unit 140 and the HMD device focus setting unit 150. The control unit 160 may include at least one operation device. In this case, the operation device may be a general-purpose central processing unit (CPU), a programmable device (e.g., CPLD or FPGA) implemented suitably for a special purpose, an application-specific integrated circuit (ASIC) or a microcontroller chip.

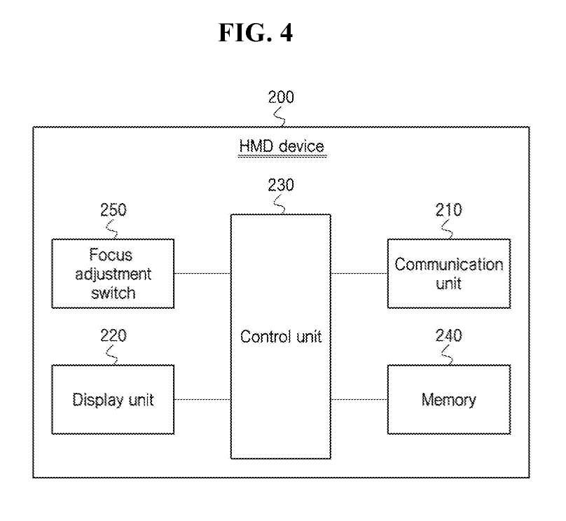

FIG. 4 is a block diagram schematically showing the configuration of the HMD device according to an embodiment of the present invention.

Referring to FIG. 4, the HMD device 200 includes a communication unit 210, a display unit 220, a control unit 230 and memory 240.

The communication unit 210 transmits and receives data to and from various electronic devices. Specifically, the communication unit 210 transmits and receives information that is necessary for the HMD device 200 to display content and to change the displayed content to and from the image server or the mobile device.

The display unit 220 displays information processed by the HMD device 200. More particularly, the display unit 220 may display content to be now displayed.

Furthermore, the display unit 220 may display a focus adjustment notification image.

Content output through the display unit 220 may overlap a common view.

The memory 240 stores information that is necessary for the HMD device 200 to display content and to change the displayed content.

In general, the control unit 230 controls an overall operation of the HMD device 200. For example, the control unit 230 may control the display unit 220 and the communication unit 210 by executing a program stored in the memory 240.

The control unit 230 controls content received through the communication unit 210 so that the content is displayed on the display unit 220.

Furthermore, the control unit 230 provides time information according to the playback of content to the image server in real time.

The HMD device 200 may be connected to at least one of the image server and the mobile device, and may receive content from at least one of the mobile device and the image server and display the received content on a screen of the HMD device 200.

The HMD device 200 configured as described above may further include a focus adjustment switch 250 for controlling a focus so that content is displayed on the display unit 220.

There is no problem when an audience normally wears the HMD device 200. However, when the audience wears the HMD device 200 in the state in which he or she has turned his or her head to the left or right, the direction of the HMD device 200 leans to the right or left. In this case, the audience who has worn the HMD device 200 cannot watch the center of normal video, and thus he or she can manually focus the HMD device 200 on the center using the focus adjustment switch 250 separately included in the HMD device 200.

The control unit 230 controls the operation of various elements of the HMD device 200, including the communication unit 210, the display unit 220, the memory 240 and the focus adjustment switch 250. The control unit 230 may include at least one operation device. In this case, the operation device may be a general-purpose central processing unit (CPU), a programmable device (e.g., CPLD or FPGA) implemented suitably for a special purpose, an application-specific integrated circuit (ASIC) or a microcontroller chip.

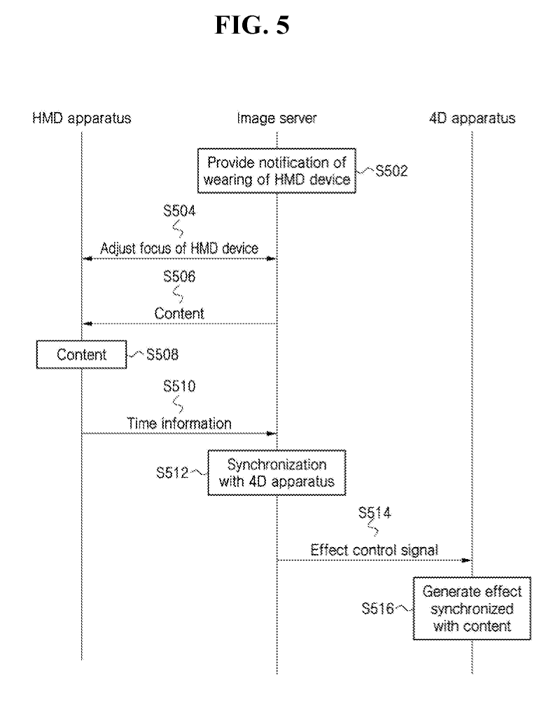

FIG. 5 is a diagram showing a method for playing back virtual reality 4D content according to an embodiment of the present invention.

Referring to FIG. 5, the image server provides notification of the wearing of the HMD device (S502) and provides a focus adjustment notification image so that the focus of the HMD device is adjusted (S504). That is, the image server outputs an HMD device wearing message, and an audience wears a corresponding HMD device by watching the HMD device wearing message. The image server provides the focus adjustment notification image so that the task of setting the focus of the audience who has worn the HMD device on the center is performed.

Thereafter, the image server transmits content to be now played back to the HMD device (S506). The HMD device displays the content (S508) and transmits time information according to the playback of the content to the image server (S510). When the HMD device displays the content, a virtual reality effect is provided to the audience.

The image server performs synchronization with a corresponding 4D apparatus through communication based on the time information received from the HMD device (S512), and transmits an effect control signal for an effect to be generated in a corresponding time to the corresponding 4D apparatus (S514). The effect control signal may be a signal for generating an effect matched with content played back by the HMD device.

The 4D apparatus that has received the effect control signal generates an effect synchronized with content that is now being played back (S516). That is, when content is started, the 4D chair provides a motion and vibration in accordance with the content, and the 4D effect device generates 4D effects, such as snow, rain, wind, dewdrops, fog, heavy rain, lightning, a scent and light, in real time in accordance with the content.

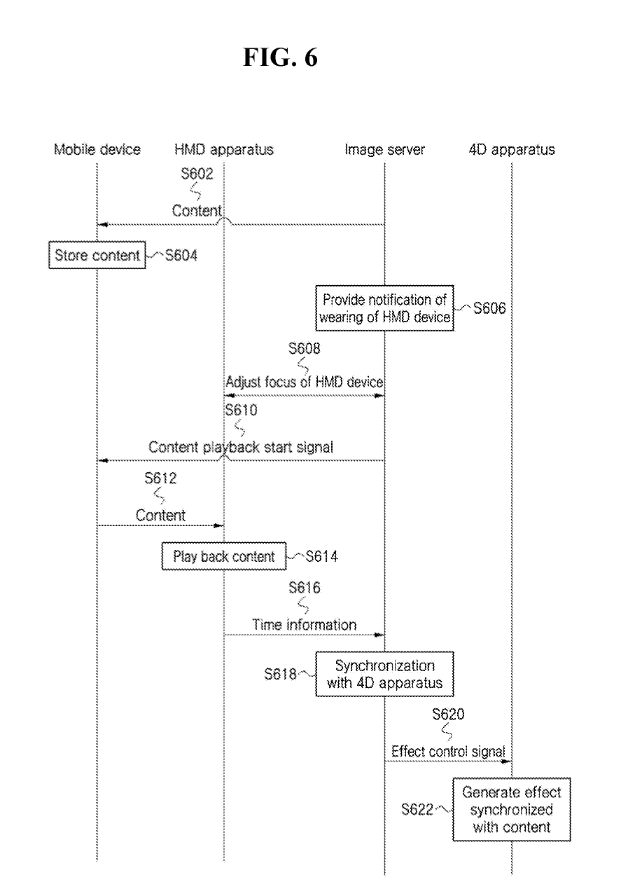

FIG. 6 is a diagram showing a method for playing back virtual reality 4D content according to another embodiment of the present invention.

Referring to FIG. 6, the image server transmits content to be now played back to the mobile device connected to the HMD device (S602). The mobile device stores the received content (S604).

Thereafter, the image server provides notification of the wearing of the HMD device (S606) and provides a focus adjustment notification image so that the focus of the HMD device is adjusted (S608).

Thereafter, the image server transmits a content playback start signal to the mobile device (S610). The mobile device transmits the content to the HMD device (S612). In this case, the mobile device transmits the content to the HMD device using the Miracast technology or the Wi-Fi Direct technology.

Accordingly, the HMD device displays the content (S614) and transmits content playback time information to the image server (S616).

The image server performs synchronization with a corresponding 4D apparatus through communication using the time information received from the HMD device (S618), and transmits an effect control signal to be generated in a corresponding time to the corresponding 4D apparatus (S620).

The 4D apparatus that has received the effect control signal generates an effect synchronized with content that is now being played back (S622).

The “method for playing back virtual reality 4D content” may be written in the form of a program, and pieces of code and code segments forming the program may be easily inferred by a programmer skilled in the art. Furthermore, a program regarding the “method for playing back virtual reality 4D content” may be stored in information storage media (or readable media) and may be read and executed by an electronic device.

As described above, those skilled in the art to which the present invention pertains will appreciate that the present invention may be implemented in other detailed forms without changing the technological spirit or essential characteristics of the present invention. Accordingly, it is to be understood that the aforementioned embodiments are only illustrative and are not limitive. It is also to be noted that the illustrated flowchart is merely sequential order illustrated to achieve the most preferred results in implementing the present invention, and other additional steps may be provided or some of the steps may be deleted.

The technological characteristics described in this specification and an implementation for executing the technological characteristics may be implemented using a digital electronic circuit, may be implemented using computer software, firmware or hardware including the structure described in this specification and a structural equivalent thereof or may be implemented by a combination of one or more of them. Furthermore, the implementation for executing the technological characteristics described in this specification may be implemented in the form of a computer program product, that is, a module regarding computer program instructions encoded on a kind of program storage media in order to control the operation of a processing system or for execution by the processing system.

In this specification, the term “apparatus (or device)” or “system” covers all of apparatuses, devices and machines for processing data, for example, apparatuses including a processor, a computer and a multi-processor or a computer. The processing system may include all types of code that form an execution environment for a computer program when code, a protocol stack, a database management system, an operating system and a combination of one or more of them that form processor firmware is requested in addition to hardware. A computer program also known as a program, software, a software application, a script or code may be written in any form of a programming language including a compiled or interpreted language or a transcendental and/or procedural language, and may also be implemented in any form including an independent program, module, a component, a subroutine or other units suitable for being used in a computer environment.

The elements for executing the technological characteristics of the present invention, included in the block diagrams and flowcharts shown in the accompanying drawings of this specification, mean a logical boundary between the elements. In accordance with a software or hardware embodiment, however, the illustrated elements and functions thereof are executed in the form of an independent software module, a monolithic software structure, code, a service or a combination of them, and are stored in a medium executable by a computer including a processor capable of executing stored program code and instructions and the functions of the illustrated elements may be implemented. Accordingly, all of such embodiments should be construed as belonging to the range of right of the present invention.

Accordingly, the accompanying drawings and technologies thereof describe the technological characteristics of the present invention, but should not be simply reasoned unless a specific array of software for implementing such technological characteristics is clearly described otherwise. That is, various other embodiments may be present and may be partially modified while having the same technological characteristics as those of the present invention. Accordingly, such modified embodiments should be construed as belonging to the range of right of the present invention.

Furthermore, the flowchart describes operations in the drawing in a specific sequence, but has been illustrated to obtain the most preferred results. It should not be understood that such operations must be executed or all the illustrated operations must be executed in the illustrated specific sequence or sequential order. In a specific case, multi-tasking and parallel processing may be advantageous. Furthermore, the separation of various system components in the aforementioned embodiments should not be construed as being requested in all of the embodiments. It should be understood that the aforementioned program components and systems may be integrated into a single software product or packaged into a multi-software product.

As described above, this specification is not intended to limit the present invention by the proposed detailed terms. Accordingly, although the present invention has been described in detail in connection with the aforementioned embodiments, a person having ordinary skill in the art to which the present invention pertains may alter, change, and modify the embodiments without departing from the range of right of the present invention. Accordingly, the range of right of the present invention is defined by the appended claims rather than the detailed description, and the present invention should be construed as covering all of modifications or variations derived from the meaning and scope of the appended claims and equivalents thereof.

1. A system for playing back virtual reality 4D content, comprising:
an image server configured to provide content or an effect control signal;
a head-mounted display (HMD) device configured to display the content; and
a 4D apparatus configured to generate an effect synchronized with the content in response to the effect control signal.

2. The system of claim 1, wherein the image server outputs an HMD device wearing message and provides a focus adjustment notification image after a predetermined specific time so that a focus of the HMD device is set.

3. The system of claim 1, further comprising a mobile device connected to the HMD device through wired or wireless communication and configured to receive content from the image server,
wherein the HMD device receives the content from the mobile device and displays the received content.

4. The system of claim 1, wherein:
the HMD device transmits content playback time information to the image server in real time, and
the image server performs synchronization with the 4D apparatus through communication using the time information.

5. The system of claim 1, wherein the 4D apparatus comprises a 4D chair configured to implement one or more effects of a ticker, vibration, an air shot, a water shot, a scent shot and a heater shot in response to the effect control signal.

6. The system of claim 1, wherein the 4D apparatus comprises a 4D effect device disposed within a theater and configured to implement at least one effect of snow, rain, wind, dewdrops, fog, heavy rain, lightning, a scent and light in response to the effect control signal.

7. The system of claim 1, further comprising a central server configured to control the image server disposed in each theater,
wherein the image server updates existing content with new content if the new content is present in the central server.

8. The system of claim 1, wherein the HMD device provides a virtual reality effect when the content is displayed.

9. The system of claim 1, wherein the HDM device, comprising:
a communication unit configured to receive content;
a display unit configured to display the received content; and
a control unit configured to control the content so that the content is displayed on the display unit.

10. The HMD device of claim 9, further comprising a focus adjustment switch configured to adjust a focus so that the content is displayed on the display unit.

11. The HMD device of claim 9, wherein the control unit transmits time information according to the playback of the content to an image server.

12. An image server, comprising:
a content service unit configured to transmit content to be now played back to an HMD device or a mobile device connected to the HMD device; and
an effect control unit configured to receive content playback time information from the HMD device, perform synchronization with a corresponding 4D apparatus based on the time information, and transmit a control signal for an effect to be generated in a corresponding time to the corresponding 4D apparatus.

13. The image server of claim 12, wherein the content service unit updates existing content with new content if the new content is present in the central server.

14. The image server of claim 12, further comprising an HMD device focus setting unit configured to output an HMD device wearing message and to provide a focus adjustment notification image after a predetermined specific time so that a focus of the HMD device is set.

15. A method of playing back virtual reality 4D content, comprising steps of:
(a) transmitting, by an image server, content to be now played back to an HMD device;
(b) displaying, by the HMD device, the content and transmitting time information according to the playback of the content to the image server;
(c) performing, by the image server, synchronization with a corresponding 4D apparatus using the time information and transmitting an effect control signal to be generated in a corresponding time to the corresponding 4D apparatus; and
(d) generating, by the 4D apparatus, an effect synchronized with the content in response to the effect control signal.

16. The method of claim 15, further comprising outputting, by the image server, an HMD device wearing message and providing a focus adjustment notification image after a predetermined specific time so that a focus of the HMD device is set prior to the step (a).

17. The method of claim 15, the step (a) further comprising steps of:
(a′) transmitting, by the image server, content to be now played back to a mobile device connected to the HMD device; and
(b′) storing, by the mobile device, the content and transmitting the stored content to the HMD device when a content playback start signal is received from the image server.

18. The method of claim 17, further comprising outputting, by the image server, the HMD device wearing message and providing a focus adjustment notification image after a predetermined specific time so that a focus of the HMD device is set after the step (a′).
